(19) United States
(12) Patent Application Publication
(10) Pub. No.: US 2025/0139705 A1
(43) Pub. Date: May 1, 2025

(54) SYSTEM AND METHOD FOR MONITORING AND PREDICTING CHANGES IN VALUES OF AN ASSET

(71) Applicant: ECF VALUATION LTD., Nehalim (IL)

(72) Inventor: Natan YALOVSKY, Nehalim (IL)

(73) Assignee: ECF VALUATION LTD., Nehalim (IL)

(21) Appl. No.: 19/006,843

(22) Filed: Dec. 31, 2024

Related U.S. Application Data
(63) Continuation of application No. 18/539,948, filed on Dec. 14, 2023, now abandoned.
Application No. 18/539,948 is a continuation of application No. 17/691,454, filed on Mar. 10, 2022, now abandoned.
Application No. 17/691,454 is a continuation of application No. PCT/IL2020/050978, filed on Sep. 8, 2020.
(60) Provisional application No. 62/899,158, filed on Sep. 12, 2019.

(51) Int. Cl. G06Q 40/06

(52) U.S. Cl. CPC G06Q 40/06

(57) ABSTRACT

Systems and methods of predicting changes in values of an asset, including receiving a report for the asset with a set of parameters relating to capitalization of cash flow, where the received set of parameters includes a value for an expected growth rate ‘eg’ for the asset, calculating a value for an estimated short-term adjustment ‘sta’ as the sum of differences in previous years, and calculating a value for an equivalent cash flow ‘ecf’ corresponding to the received set, according to the equation: ecf=(cfn/(1+eg))\hat{ }(n−m) where ‘n’ is a predefined representative capitalization year and ‘m’ is a different predefined year such that a capitalized cash flow of the representative year is calculated until the first year, and where ‘cfn’ is the equivalent cash flow for the year ‘n’, and ‘cfm’ is the equivalent cash flow for the year ‘m’.

### CROSS REFERENCE TO RELATED APPLICATION

This application is a Continuation Patent Application of U.S. patent application Ser. No. 18/539,948, filed on Dec. 14, 2023, which is a Continuation Patent Application of U.S. patent application Ser. No. 17/691,454, filed on Mar. 10, 2022, which is a Continuation Patent Application of PCT International Application No. PCT/IL2020/050978, International Filing Date Sep. 8, 2020, claiming the benefit of U.S. Provisional Patent Application No. 62/899,158, filed Sep. 12, 2019, which are hereby incorporated by reference.

### FIELD OF THE INVENTION

The present invention relates to data analysis of asset values. More particularly, the present invention relates to systems and methods for monitoring and predicting changes in values of assets.

### BACKGROUND OF THE INVENTION

The valuation of assets (e.g., tradable and non-tradable assets such as stock exchange shares and/or projects, debt instruments such as bonds and loans, hereinafter referred to as products) is a complex task that requires a professional analyst. While the majority of people today are at least partially involved with these investments both directly in portfolio management and indirectly with long-term savings, pension, etc., many such investors lack the technical and/or professional tools to make informed investment decisions. For example, such decisions may be based on future predictions on the value of a particular asset.

Another difficulty in estimation of the value of the asset can be the multiplicity of assets as well as their types, the various influencing parameters, the available information, the different activity sectors and the practiced methodologies are a challenge to the success of the estimation and/or evaluation of the asset.

Current approaches to asset valuation include several main methods, each of which has advantages and disadvantages. The current method of estimating direct value requires a great deal of resources that is only attainable for professional investors. Statistical methods and correlations or a typical technical analysis method is usually based on history of the assets and may ignore forecasts and predictions.

Some approaches include using machine learning with artificial intelligence and/or the wisdom of the crowds which are mainly concentrated on random information on social networks instead of the relevant parameters.

An example of a fairly simplistic method that is prevalent among many investors is the method of estimating a share price based on two parameters: the profit per share and the embedded profit multiplier in the market. The simplification usually stems from the inability to accurately estimate both the representative share profit and the market embedded profit multiplier based on a collection of data of other companies, and does not take into account the impact of other critical factors such as management forecasts, leverage, trends in the industry and in society, etc.

Another example is a discounted cash flow (DCF) model with a capitalization rate based on the yield on capital and the debt. In this method, there are many limitations that require the use of assumptions, such as the leverage rate that should be part of the results and not part of the assumptions. Another limitation relates to the assumption and use of market indices that are not necessarily appropriate for different types of assets and the changes in these indices that are not related to the asset being valued.

The following table shows parameters for the DCF model:

| PARAMETER | MEANING | RECEIVED FROM |
|---|---|---|
| d | debt | financial reports/business |
| | | plan |
| rd | real debt or debt price | actual financing costs of |
| | | the company |
| T | taxes | statutory tax rate |
| rf | risk-free interest rate | given in the market |
| g | growth rate | assessment by the user |
| cf1-n | predicted cash flow | assessment by the user |
| | for 1-n years | |
| cfn | eternal predictive cash | assessment by the user |
| | flow from the year ‘n’ | |
| p | price of share | given in the market |
| NoS | number of shares | given in the market |
| e | capital value | given in the market |
| | | e = p * NoS |
| v | enterprise value | calculated with v = D + e |

From these parameters, the following calculations are usually performed: ‘my’ the market returns are usually estimated based on historical performance or determined empirically or estimated otherwise by the user (e.g., a potential investor). The ‘β’ coefficient of correlation between the yield of the share and the market yield, usually calculated based on a statistical calculation against shares indices or existing additional statistical calculations using different methods. The return on equity ‘re’ is calculated with the equation: re=rf+(my−rf)* β.

In theory, the model may assume a correlation also in the different level of leverage between the market and the stock share, but usually there is difficulty in identifying the level of market leverage when it is related to adaptation to the index and is usually not adapted for a group (e.g., a reference group). There is another difficulty in tracking changes in both market and stock share leverages during the tested period.

The capitalization rate or weighted average cost of the capital ‘w’ of the activity flows may be calculated as:

$$w = \frac{D}{V} * rd * ( 1 - T ) + \frac{E}{V} * re$$

in which ‘w’ weighs the financing rate (D/V) and/or net cost of the debt and equity rate (E/V), is complementary to 1. The calculation of the capital value ‘E’ is performed by the equation E=V−D. The calculation of the enterprise value ‘V’ is performed by discounting the expected cash flow statement includes all future cash flows according to the future year with the equation:

$$V = \frac{cf 1}{( 1 + w )} + \frac{cf 2}{{( 1 + w )}^{2}} + … + \frac{cfn}{( w - g ) {( 1 + w )}^{n - 1}}$$

Sometimes the theoretical basis of this model analyzes the relationship between the performance of a single share and a general portfolio of assets, most of which are not in the same area of activity as the appraised asset. In many cases, it is common for professional investors to rely on the relationship between a single share and the SP500 index, such that a general prediction cannot be achieved. It is, therefore, difficult to achieve proper analysis and prediction for the value of an asset.

### SUMMARY

There is thus provided, in accordance with some embodiments of the present invention, a method of predicting changes in values of an asset, the method including: receiving, by a processor, a report for the asset with a set of parameters relating to capitalization of cash flow, where the received set of parameters includes: a value for a debt ‘D’ for the asset, a value for a cost of the debt ‘rd’ for the asset, a value for a tax ‘T’ for the asset, a value for an expected growth rate ‘eg’ for the asset, calculating, by the processor, a value for an estimated short-term adjustment ‘sta’ as the sum of differences in previous years, and calculating, by the processor, a value for an equivalent cash flow ‘ecf’ corresponding to the received set, according to the equation: ecf=(cfn/(1+eg))\hat{ }(n−m), where ‘n’ is a predefined representative capitalization year and ‘m’ is a different predefined year such that a capitalized cash flow of the representative year is calculated until the first year, and where: ‘cfn’ is the equivalent cash flow for the year ‘n’, and ‘cfm’ is the equivalent cash flow for the year ‘m’.

In some embodiments, a reference group with at least one reference asset is identified (e.g., by the processor), and a report is received (e.g., by the processor) for each asset in the reference group. In some embodiments, the report includes details for at least one of: a equivalent cash flow (‘ecf’) and liabilities. In some embodiments, a report is received (e.g., by the processor) with a set of parameters relating to capitalization of cash flow, where the received set of parameters includes: a value for a calculated asset worth ‘v’ for the asset, and a value for a capital market value ‘e’ for the asset, a value is calculated for a return on equity inherent in the share price ‘re’ for the asset, and w=D/v*rd*(1−T)+e/v*re is calculated.

In some embodiments, the calculated equivalent cash flow ‘ecf’ is normalized for each asset in the reference group based on the share price ‘re’ for the asset. In some embodiments, adjustments to the equivalent cash flow (‘ecf’) are calculated based on differences for at least one other year. In some embodiments, a looping algorithm is applied to calculate three equations:

$$V = D + E \qquad ( I )$$

$$V = \frac{ecf}{( W - eg )} - sta \qquad ( II )$$

$$W = \frac{E}{V} * RE - \frac{D}{V} * rd * ( 1 - T ) . \qquad ( III )$$

In some embodiments, an implied market yield ‘my’ is calculated for the reference group. In some embodiments, a return on equity ‘re’ is calculated with the equation: RE=rf+(my−rf)*β, where ‘rf’ is the risk-free interest rate and ‘β’ is the standard correlation coefficient.

There is thus provided, in accordance with some embodiments of the present invention, a system for prediction of changes in values of an asset, the system including: a processor, and a database, coupled to the processor and configured to store a report for the asset with a set of parameters relating to capitalization of cash flow, where the processor is configured to: receive the report from the database, where the received set of parameters includes: a value for a debt ‘D’ for the asset, a value for a cost of the debt ‘rd’ for the asset, a value for a tax ‘T’ for the asset, a value for an expected growth rate ‘eg’ for the asset, calculate a value for an estimated short-term adjustment ‘sta’ as the sum of differences in a previous year, and calculate a value for an equivalent cash flow ‘ecf’ corresponding to the received set, according to the equation: ecf=(cfn/(1+eg))\hat{ }(n−m), where ‘n’ is a predefined representative capitalization year and ‘m’ is a different predefined year such that a capitalized cash flow of the representative year is calculated until the first year, and where: ‘cfn’ is the equivalent cash flow for the year ‘n’, and ‘cfm’ is the equivalent cash flow for the year ‘m’.

In some embodiments, the processor is further configured to: identify a reference group with at least one reference asset, and receive a report for each asset in the reference group. In some embodiments, the report includes details for at least one of: an equivalent cash flow (‘ecf’) and liabilities. In some embodiments, the processor is further configured to: receive a report with a set of parameters relating to capitalization of cash flow, where the received set of parameters includes: a value for a calculated asset worth ‘v’ for the asset, and a value for a capital market value ‘e’ for the asset, calculate a value for a return on equity inherent in the share price ‘re’ for the asset, and calculate w=D/v*rd*(1−T)+e/v*re.

In some embodiments, the processor is further configured to normalize the calculated equivalent cash flow ‘ecf’ for each asset in the reference group based on the share price ‘re’ for the asset. In some embodiments, the processor is further configured to calculate adjustments to the equivalent cash flow (‘ecf’) based on differences for at least one other year. In some embodiments, the processor is further configured to calculate an implied market yield ‘my’ for the reference group. In some embodiments, the processor is further configured to calculate a return on equity ‘re’ with the equation: RE=rf+(my−rf)*β, where ‘rf’ is the risk-free interest rate and ‘β’ is the standard correlation coefficient.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 shows a block diagram of a system for predicting changes in values of an asset, according to some embodiments of the invention;

FIG. 3 shows a flowchart for prediction of changes in values of an asset, according to some embodiments of the invention;

FIG. 4 shows a flowchart for a method of predicting changes in values of an asset, according to some embodiments of the invention;

FIG. 5A which shows a table with an example of ‘ECF’ and embedded multiplier calculation by the system for predicting changes in values of an asset, for a period of several years, according to some embodiments of the invention; and

FIG. 5B shows a table with an example of comparison of ‘ECF’ and ‘STA’ value calculation by the system for predicting changes in values of an asset, for several companies, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

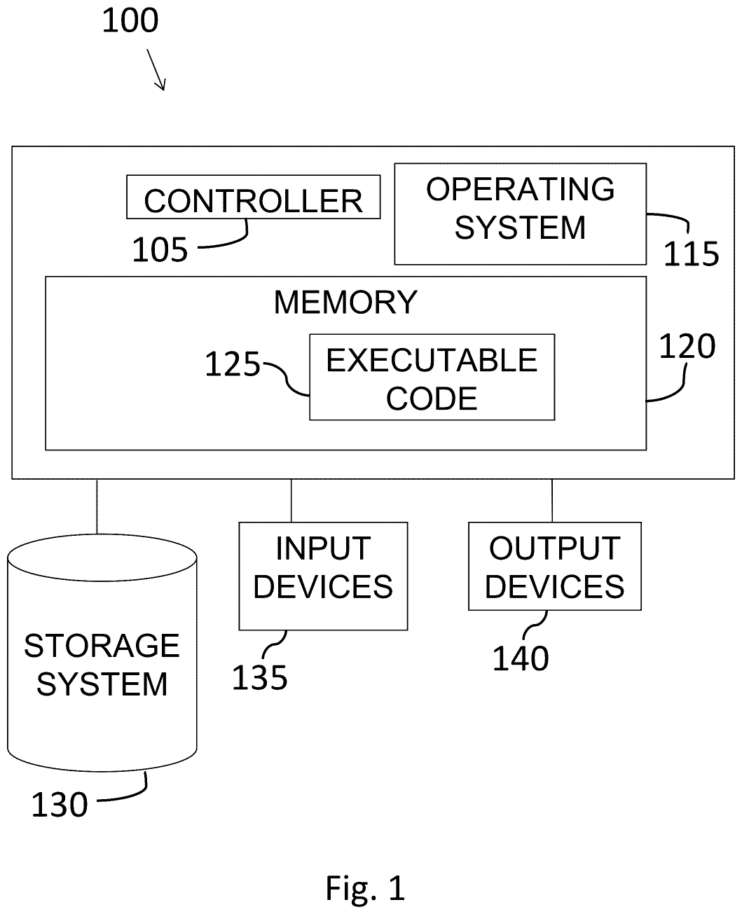

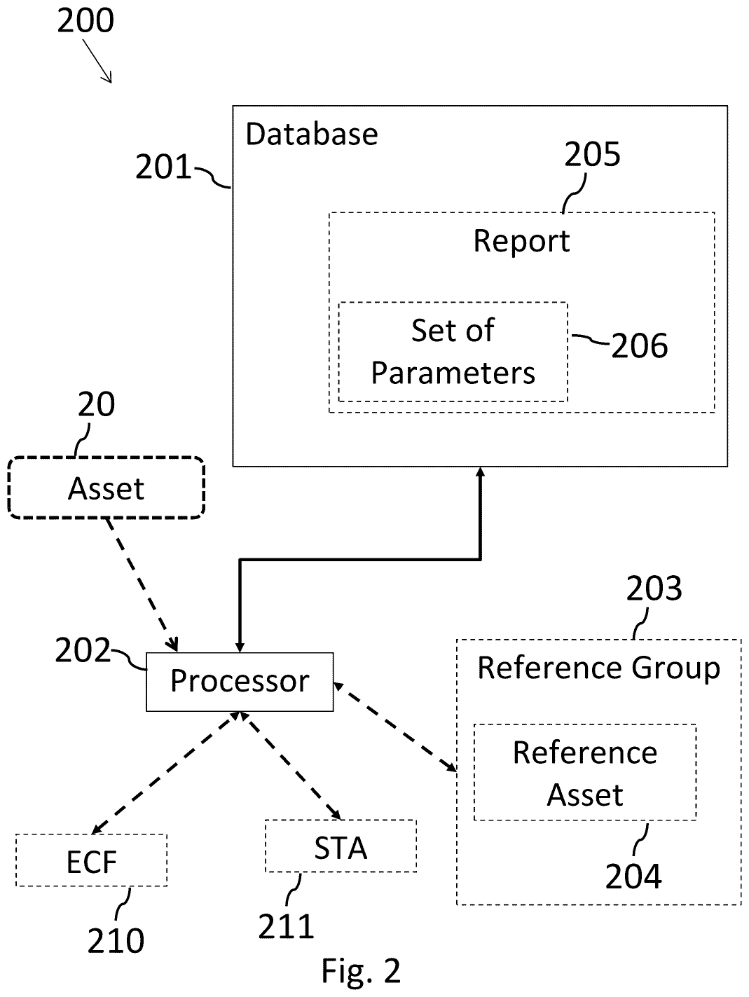

Reference is made to FIG. 1, which shows a block diagram of an examplary computing device, according to some embodiments of the invention. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, devices, etc. More than one computing device 100 may be included in, and one or more computing devices 100 may act as the components of, a system according to some embodiments of the invention. The computing device or controller of FIG. 1 may act as the various computing devices or controllers of FIG. 2, e.g. the devices communicating on a network, such as a processor receiving a dataset of market values for assessment.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA) and/or system on a chip (SOC) that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein, or act as the “devices” described herein, or perform other functions.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include any suitable input devices, components or systems, e.g., a detachable keyboard or keypad, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, cause the processor to carry out methods disclosed herein. For example, a storage medium such as memory 120, may include computer-executable instructions such as executable code 125 and a controller such as controller 105 may execute these instructions or executable code 125.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of chips, FPGAs or SOCs, a plurality of computer or network devices, or any other suitable computing device. For example, a system as described herein may include one or more devices such as the computing device 100.

Some embodiments provide systems and methods for prediction of changes in values of an asset compared to a reference group thereby to provide users, for instance investors, information regarding the asset that was not available with previous DCF methods. Thus, these predictions may be provided as a decision assisting tool to allow users reaching investment decisions faster than previously possible and in some cases, providing the ability to understand and to act accordingly.

Reference is made to FIG. 2 which shows a block diagram of a system 200 for predicting changes in values of an asset 20, according to some embodiments of the invention. The direction of arrows in FIG. 2 may indicate the direction of information flow. In some embodiments, software elements in FIG. 2 are indicated with a dashed line while hardware elements are with a solid line.

The system 200 may include a database 201 to store information on one or more assets, for example assets in the same field and/or in being in a reference group. The information stored for these assets may be used for future analysis and/or prediction of behavior of similar assets. It should be noted that, when looking at similar assets, similar behavior may be expected so when values are calculated for the reference group, a more accurate calculation may be achieved.

According to some embodiments, the system 200 may include a processor 202, coupled to the database 201, the processor 202 configured to analyze data so as to achieve a prediction for the changes in value of the asset 20. In some embodiments, the processor 202 may analyze data to predict changes in price of a tradable stock based on valuation of the company and/or differences between cash flow computations, as further described hereinafter. In some embodiments, the processor 202 may analyze data to evaluate non-negotiable income-producing assets and/or conduct simulations for calculating the value of a company. In some embodiments, the processor 202 may analyze data to perform historical comparison of valuations and comparison with other companies.

In some embodiments, the processor 202 may analyze data to perform other computations that are also possible with previous methods such as assessing the state of the market, for instance the implied market yield and/or forecast of change in market prices, for instance measurement of gaps deriving from extreme market conditions such as the macro premium parameter. The processor 202 may also analyze data to assess the state of the market and its historical behavior and/or calculate evaluate comparison of indices of a single company and of the market such as leverage multiplier leveraging as well as measurement of the debt price of a company.

The following table shows parameters for the improved DCF model, according to some embodiments:

| PARAMETER | MEANING | RECEIVED FROM |
|---|---|---|
| d | debt | financial reports/business plan |
| D | estimated debt | ’d’ or other estimation by the user |
| rd | debt price | estimated financing costs of the |
| | | company |
| T | Taxes | expected tax rate |
| rf | risk-free interest rate | given in the market |
| g | growth rate | assessment by the user |
| cf1-n | predicted cash flow for 1-n | assessment by the user |
| | years | |
| cfn | eternal predictive cash | assessment by the user |
| | flow from the year ‘n’ | |
| e | capital value in market | given in the market e = p*NoS |
| E | capital value | calculated |
| v | enterprise value in market | given in the market by v = d + e |
| V | enterprise value | calculated with V = D + E |
| p | price of share | given in the market |
| P | predicted price of share | calculated with P = E/NoS |
| NOS | number of shares | given in the market |
| my | the implied and/or | calculated |
| | historical market yield | |
| re | return on equity as implied | calculated |
| | in the market | |
| β | standard correlation | statistical calculation against existing |
| | coefficient | stock indices and checking the |
| | | correlation level |
| βL | leverage correlation | calculated |
| | coefficient | |
| RE | forecasted return on equity | calculated RE = rf + (my rf) * β1 |
| ra | discount rate | calculated ra = w − eg |
| w | capitalization rate of the | calculated with weights for the |
| | activity flows | financing rate of the debt and of the |
| | | embedded owners rate of return |
| W | forecasted capitalization | calculated |
| | rate | |

NEW PARAMETERS:

| | | |
|---|---|---|
| sta | short time adjustment | calculated |
| eg | equivalent growth | calculated |
| cfa | latest cash flow without | assessment by the user |
| | non-permanent influences | |
| ecf | equivalent cash flow from | assessment to match and give equal |
| | year 1 | value to calculation of individual |
| | | cash flow per each year and the |
| | | representative year |
| | | ecf = cfn/(1 + eg)\hat{ }n − 1 |
| HL | level of hope | the ratio between ‘ecf’ and ‘cfa’ |
| | | HL = ecf/cfa − 1 |
| str | short term cash flow impact ratio | $str = sta / \frac{ecf}{( w - eg )}$ |
| ecfX | ecf multiplier | ecfX = (1 + str)/(w − eg) |

According to some embodiments, the enterprise value in the market may be calculated with the addition of the “eternal” equivalent cash flow with the short-term adjustments (discounted or not discounted), as further described hereinafter:

$$V = \frac{ecf}{( w - eg )} + sta$$

where ‘ecf’is the equivalent cash flow, and ‘sta’ is the capitalization of the short-term adjustments, where ‘sta’ may be a positive or a negative value. In some embodiments, the ‘sta’ may be calculated with:

$$sta = {\sum }_{i = 1}^{n - 1} \frac{\frac{cfn}{{( 1 + eg )}^{n - i}} - cfi}{{( 1 + w )}^{i}}$$

The calculation of values may be extracted from market data and/or market prices only in relation to the activity measured.

In order to evaluate and/or predict the value of the asset, it may be required to retrieve the stock return “RE” and/or the market return “MY” of the stock reference group embodied in the market prices for that asset. Additionally, the historical correlation between stock return and benchmark return may be checked and the expected share price may be estimated based on the stock return and/or the historical correlation.

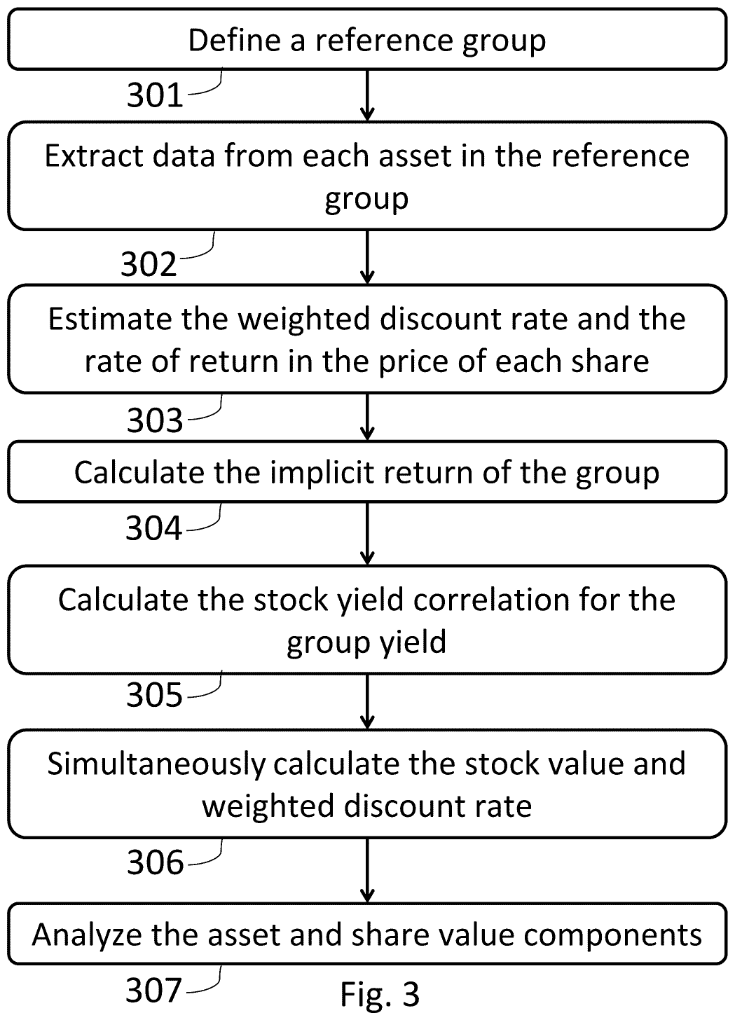

Reference is made to FIG. 3, which shows a flowchart for prediction of changes in values of an asset, according to some embodiments of the invention.

In order for changes in price of a tradeable asset to be predicted, initially a reference group 203 may be defined 301. The reference group 203 may include at least one other asset 204 that may be similar to the asset 20, for example having at least one common attribute (e.g., both asset 20 and reference group 203 may include companies in the renewable energy market). In some embodiments, the reference group 203 may be defined by the user of system 200, and/or defined automatically by processor 202 based on the given asset 20. For example, once the asset 20 is identified by the processor 202, the reference group 203 may be automatically created with other assets from the same field and/or industry and/or sector.

In some embodiments, the database 201 may store a report 205 for each asset 204 in the reference group 203 (e.g., received by the processor 202) with a set of parameters 206 relating to capitalization of cash flow.

The user may build a set of assets (e.g., companies) to be used in relation to the measured asset. These groups may be fixed and retained in future calculations. In some embodiments, such reference groups may be shared between different users, for instance as an alternative use of structured indexes. In some embodiments, a structured index may be used instead of a unique reference group.

In some embodiments, the processor 202 may extract data 302 from each asset in the reference group 203. For example, the processor 202 may receive a financial report or business plan for at least one asset in the reference group 203. The analysis may include estimating the operating assets (e.g., of a single company), its working capital assets, its needed working capital asset, and other data for establishing the valuation. The data to be extracted from the financial report may include: the amount of working capital asset, the amount of debt expected to be required to run the activity (D); the expected debt cost to apply to the activity (rd); the tax rate expected to apply to the activity (T); the estimate growth rate of activity and cash flow (eg); the assets and/or liabilities that are not part of the assets required to operate; and having sufficient working capital. For estimation of the equivalent cash flow ‘ecf’ and the short-term adjustments ‘sta’, a predicted set of reports may be generated with the cash flow expected to be received in that year, including the terminal cash flow of the representative year.

The estimated cash flow ‘ecf’ may be calculated as the capitalized value for the year's flow representing ‘n’ at the rate of growth from the representative year to the end of the first year:

$$ecf = \frac{cfn}{{( 1 + eg )}^{n - 1}} .$$

In some embodiments, the growth rate ‘eg’ may be defined to vary according to a definition of constant, decreasing, or rising expansion, with the short-term adjustment ‘sta’ set to be zero. In some embodiments, individual growth rates may be defined, for instance for predefined time periods, with the short-term adjustment ‘sta’ may be set to be zero or another estimation. In some embodiments, the ‘ecf’ and/or ‘sta’ may be determined by calculating the expected ‘ecf’ for the first year while also calculating the difference between the ‘ecf’and the expected cash flow for each year until the representative year ‘n’.

The difference between the estimated cash flow rate for each year ‘cfm’ versus the estimated cash flow rate in the representative year may be calculated with the capitalized for value for that year ‘m’ as:

$$Δ = \frac{cfn}{{( 1 + eg )}^{n - m}} - cfm .$$

This may be the base for the estimation of the effect of short-term differences as the sum of all the differences in cash for each year with or without discounting. In some embodiments, accurate short-term difference calculations may be carried out by using the advanced model in the traditional approach to calculate the exact amount of value when the value may be recalculated, and the difference obtained as short-term differences. In a first loop, the calculation may be based on the advanced model; in a second loop, the calculation may be based on the core calculation; and in a third loop, the calculation may be based on estimation of the short-term differences as their exact sum and recalculation.

Accordingly, the estimated short-term adjustment ‘sta’ may be calculated as the sum of differences in a previous year. An analyst having the ‘ecf’ and/or ‘sta’ values may achieve improved decision regarding the predicted value of the asset 20. In some embodiments, the estimation of the ‘sta’ may be calculated as discounting the amount of cumulative differences to half of the period until the representative year ‘n’ based on the estimated discount rate or average (e.g., 7.5%). In some embodiments, the cumulative differences may be set to be zero.

In some embodiments, the ‘ecf’ and/or ‘sta’ may be determined based on the condition that the eternal capitalization based on the ‘ecf’ adjusted with the ‘sta’ may be equivalent and/or equal to the result of calculating capitalization for a set of cash flow (e.g., calculated for different years).

In some embodiments, a possible estimation for accuracy for estimating the ‘sta’ may be achieved by capitalizing any difference in each year's cash flow for each year from the relevant year to the first year and the sum of the differences. The discount rate may, therefore, be an initial estimate of the average discount rate expected as the result. In some embodiments, accuracy for estimating the ‘sta’ and the total value may include forward discounting in order to adjust the discount periods (e.g., estimating a half year forward as all cash flows may be received in the middle of the period).

In some embodiments, the sum of the differences may be calculated based on an ‘ecf’ that is estimated in relation to a particular year and/or an average of past and/or future years. In some embodiments, the sum of the differences may be calculated based on adjacent years and/or years in a predefined range. In some embodiments, the sum of the differences may be calculated based on the ‘ecf’ relative to a predefined anchor with a corresponding growth forecast and/or other discount.

In some embodiments, the weighted discount (implicit) rate and the (implicit) rate of return in the price of each share may be estimated 303. The average discount rate may be calculated according to:

$$v = \frac{ecf}{( w - eg )} + sta .$$

The implied return of the stock may be calculated when the differences in capitalization are also discounted at the average discount rate ‘w’ according to:

$$w = \frac{e}{v} * re + \frac{D}{v} * rd * ( 1 - T ) .$$

The calculation may be simultaneous due to the complex definition integrated between the equations:

$$v = D + e \qquad ( I )$$

$$v = \frac{ecf}{( w - eg )} + sta \qquad ( II )$$

$$w = \frac{e}{v} * re + \frac{D}{v} * rd * ( 1 - T ) \qquad ( III )$$

In case the exact differences are accurate in capitalization, these values may also be discounted at the average discount rate ‘w’. The market price and/or number of shares of the asset may be read, and the value of equity may be calculated (e.g., by processor 202) according to the market price ‘e’. Similarly, the amount of debt expected to apply to activity ‘D’ may be read, and the value of the activity may be calculated as the amount of equity and debt ‘v’.

The value of the permanent component based on the ‘ecf’ together with the of the short-term adjustment ‘sta’ amount may be calculated and set as the total value, such that the permanent weighted discount rate of ‘ra’ activity that is inherent in market prices may be calculated by dividing the predicted or estimated cash flow ‘ecf’ by ‘ra’. The rate ‘ra’ may represent the weighted discount rate minus the growth forecast rate: ra=w−eg, where ‘w’ represents the weighted discount rate inherent in market prices.

In some embodiments, the level of hope ‘HL’ may be defined as a measure of the level of reliability and/or assurance of achieving the predicted value of the asset, for instance based on the component and the actual cash flow, neutralizing non-permanent effects. The ‘HL’ measure may be accordingly embedded as part of the evaluation results where HL=ecf/cfa−1. In some embodiments, the level of hope ‘HL’ for the entire reference group may also be derived based on average values in the market. For example, the hope level ratio may indicate the gap between the estimate expected for many years and the actual implementation in the previous period, with large ratios raising question marks of plausibility. If two companies, company ‘A’ and company ‘B’, both have actual ‘cfa’ cash flow of 1000, and the calculated ‘ecf’ for company ‘A’ is 1010 while the calculated ‘ecf’ for company ‘B’ is 1100, then the ‘HL’ may be calculated as 1% for company ‘A’ and 10% for company ‘B’. It should be noted that a 10% discount or premium on the cash flow relative to the actual value in practice may require justification using the ‘ecf’ value and/or the ‘HL’ value, instead of just general estimation.

In some embodiments, the implicit return of the group may be calculated 304, as well as the level of leverage of the group, and/or the macro premium, and/or the marketable premium, and/or the average debt cost, and/or the average market multiplier and other parameters for the group. A weighted average of the market returns may be calculated (e.g., by processor 202) for all group shares, with ‘MY’ as the market return.

The implicit return capitalization rate ‘w’ may be measured by summing all estimated cash flows “ecf” of all group assets and dividing them at each point in time by all group value minus the total short-term differences “sta” of all group assets. For the weighted average of the group, the average ‘eg’ for the group may be deducted: w=ecf/(v−sta)−eg.

In some embodiments, the implicit market yield of all group shares ‘MY’ may be calculated as a weighted average of the return on equity of all the shares in the reference group, for instance relative to the weight of the value of each share in the group. In some embodiments, the implicit market yield of all group shares ‘MY’ may be calculated as a weighted average of the historical returns of all the group's shares for a given year and/or as a mean of several years.

In some embodiments, a weighted average leverage level and/or average cost of debt and/or average market profit multiplier and/or additional parameters for the reference group may be calculated based on the value of each asset (e.g., a company) in the group. In some embodiments, a macro premium may be calculated (or defined as zero) and/or defined as any number as an estimate. In some embodiments, the calculated macro premium may not be discrete but may be measured in relation to a sequence of calculations in the past. The premium may measure the level of the missing yield on market prices due to inherited stress or stress situations, excess or shortage, and/or low or high alternative interest rates. The macro premium may also be calculated using the implicit market return parameter calculated above, based on each asset's estimated cash flow and the regression line measurement and the deviation from the regression line at the test point constitutes the macro premium.

In some embodiments, a trade premium may be calculated (or defined as zero) and/or defined as any number as an estimate. In some embodiments, other influencing values may be similarly calculated and/or defined as specific value, thereby user flexibility in selecting other parameters such as control premium or synergy, etc.

In some embodiments, the stock yield correlation for the group yield ‘β’ may be calculated 305. The expected rate of return from the stock may be calculated according to: RE=rf+(my−rf)*β. A precondition for that result may be the “coefficient rate” with statistical calculations, which may be medium or high, usually above 0.3 in the range between zero and one.

The level of leverage measured in calculating the correlation may be adjusted with the relative leverage levels of the stock and the market at the measurement date. It should be noted that this calculation may not be possible without retrieving the average leverage level information in the market and its implementation at all the test points of the yield correlation.

In some embodiments, the expected rate of return may be calculated from the stock value. For example, a standard fixed correlation rate may be defined or a different equivalent formula may be used between two variables. In case that the index representing the assets (e.g., the companies) in which a reference group may be built, the calculations may be similar to the previous model. In case that the calculations rely solely on the index without building the reference group, then some data may be missing in order to calculate the implicit market return, the macro premium level of market leverage and other estimates as well. The historical comparison and/or standard setting may be therefore used to calculate the expected rate of return.

In some embodiments, the expected rate of return may be calculated from the stock value with the equation RE=(my−rf)*β for the return on equity.

In some embodiments, the expected rate of return may be calculated from the stock value defining on a standard fixed correlation and/or using a different formula between two variables. In some embodiments, the expected rate of return may be calculated with adjustment of the leverage level (e.g., with adjusted β).

In some embodiments, the stock value and weighted discount rate may be simultaneously calculated 306. For this calculation, three equations need to be solved in order to determine the required parameters. The calculation may be simultaneous due to the complex definition integrated between the equations:

$$V = D + E \qquad ( IV )$$

$$V = \frac{ecf}{( W - eg )} + sta \qquad ( V )$$

$$W = \frac{E}{v} * RE + \frac{D}{V} * rd * ( 1 - T ) \qquad ( VI )$$

In some embodiments, the exact differences in capitalization are also discounted at the average discount rate ‘w’. Accordingly, an average weighted discount rate may be obtained as well as the asset's value.

Simultaneous calculation of the weighted discount rate and/or stock value may be therefore be carried out by solving two equations:

$$V = \frac{ecf}{( W - eg )} + sta \qquad ( IV )$$

$$V = D * \frac{re - rd * ( 1 - T )}{RE - W} \qquad ( V )$$

The method of calculation may be complex, since it is capitalization calculations with robustness, such that the processor may apply a looping algorithm where the calculated value is guessed and matched to the equation until the correct value may be retrieved (e.g., using at least one machine learning algorithm to calculate these equations).

In some embodiments, the equation may be divided into two parts: a fixed part and a variable part. A calculation loop of guessing may be applied, and the appropriate discount rate may produce a result where the variable part is the same as the fixed part. In each loop, the difference between the variable part and the fixed part may be calculated, and in the next loop, an attempt may be made to reduce the gap accordingly. Once a substantially small gap is reached, for instance once the gap is smaller than a predetermined threshold, the looping algorithm may be stopped. In some embodiments, the difference may be halved for each loop in order reduce the required calculation time until the desired result may be reached.

In some embodiments, the calculation may be based on the previously defined discounted set of cash flows. The simultaneous calculation is based on a simultaneous calculation of the weighted discount rate and/or stock value, thereby solving two equations:

$$V = \frac{{cf}_{1}}{( 1 + W )} + \frac{{cf}_{2}}{{( 1 + W )}^{2}} + … + \frac{cfn}{( W - eg ) {( 1 + W )}^{n - 1}} \qquad ( VI )$$

$$V = D * \frac{RE - rd * ( 1 - T )}{RE - W} \qquad ( VII )$$

where the calculation may be more complex since it is a set of cash flows and discounted capitalization calculations. Thus, a more accurate result of the ‘ecf’ and ‘sta’ may be achieved that are different than the estimate made in the early stages for calculating the implicit market return.

In some embodiments, the analysis of company and share value components may be determined 307, as well as calculation of expected stock price, and/or measurement of the gap from the market price. For the final analysis, the processor 202 may display for the user the calculated values (e.g., the ‘ecf’ and/or the ‘sta’ and/or str, and/or HL) with the predicted share price and/or asset value, such that the user may receive a prediction and/or forecast and/or suggestion for the effect of each component on the expected price calculation.

Thus, the data may be presented in a user-friendly way despite the large amount of input data so as to allow a human user to reach a decision more effectively, due to the ability to view the equivalent cash flow and the short-term effect as a single parameter compared to previous methods displaying a plurality of different variables.

In some embodiments, the calculated equivalent cash flow ‘ecf’ may be adapted by converting the representative cash flow to the equivalent cash flow for each asset in the reference group.

According to some embodiments, an indicative debt price may be calculated (e.g., by the processor 202) in several methods. The indicative debt price may be calculated as allocation of debt price and yield to the owner as a proportion of the funding ratio of the two factors. The two-factor financing ratio may indicate the collateral coverage ratio that reduces the lender's risk and, therefore, also allows for a reduction in the price of debt. On the other hand, the excess risk that the owner takes on allows for a higher return, given that the plan worked as expected.

In a first model (e.g., a 1080 model), the weighted discount rate distribution between the lender and the owner may be calculated as follows: up to a 10% leverage level, the lender expects to receive the ‘rf’ plus commission, and above the leverage level, 80% model may not offer price. Up to an 80% leverage level, an exponential calculation of the indicative debt price may be performed based on the actual leverage level ‘L’ and the weighted capital price of the stock and risk-free interest rate ‘rf’:

$$rd = rf * ( w / rf ) \hat{} ( ( L - 0.1 ) / ( 0.8 - 0.1 ) ) + fee$$

In another model, the lender's demand for compensation for interest at the level of the gap between the implied share return and risk-free interest may be calculated beyond the base interest rate, in line with the financing rate.

For example, in a riskless interest rate 2% ‘rf’, the weighted discount rate of activity 10% ‘w’ and financing ratio 60% ‘L’, the risk return may be calculated as: (1+w)/(1+rf)−1 with 1.1/1.02−1=7.8%. The compensation for risk may be calculated as: 1*(1+w)/(1+rf)−1 with 7.8%*60%=4.68%. The indicative debt price before fees may be calculated as: 1*(1+w)/(1+rf)−1+rf with 2%+4.68%=6.68%. It should be noted that this is an indicative long-term debt price before commissions and assuming a lender borrows at risk-free interest. Another calculation to retrieve an indicative debt price may include using an average of previous methods. For shorter-term debt calculation purposes, in both models, interest rate adjustments may be made for a shorter period of time in accordance with the behavior of the risk-less yield curve for different ranges. In some embodiments, the system may calculate debt as a function of a specific level of collateral for a specific debt. This calculation may differ from the total indicative long-term debt price level.

It should be noted that a leveraged adjusted multiplier and/or the comparison of standard leveraged adjusted multipliers at a standard leverage level may allow for a more accurate comparison of profit multipliers by neutralizing the effect of different leverage levels between stocks and the market as a whole. Where there is a high leverage and want to calculate a lower leverage multiplier, the owners may accordingly invest an additional amount in the asset (e.g., the company), and this amount may be used to reduce debt so that activity and business value may not change but only the financing relationship between the owner and the lender. The same may apply in the opposite direction, assuming an additional loan to pay a dividend to the owner. When there is a change in the level of debt, this has an impact on financing expenses as well as a tax effect on these financing expenses, and, therefore, the equivalent profit may be recalculated after the financing and tax costs have been adjusted.

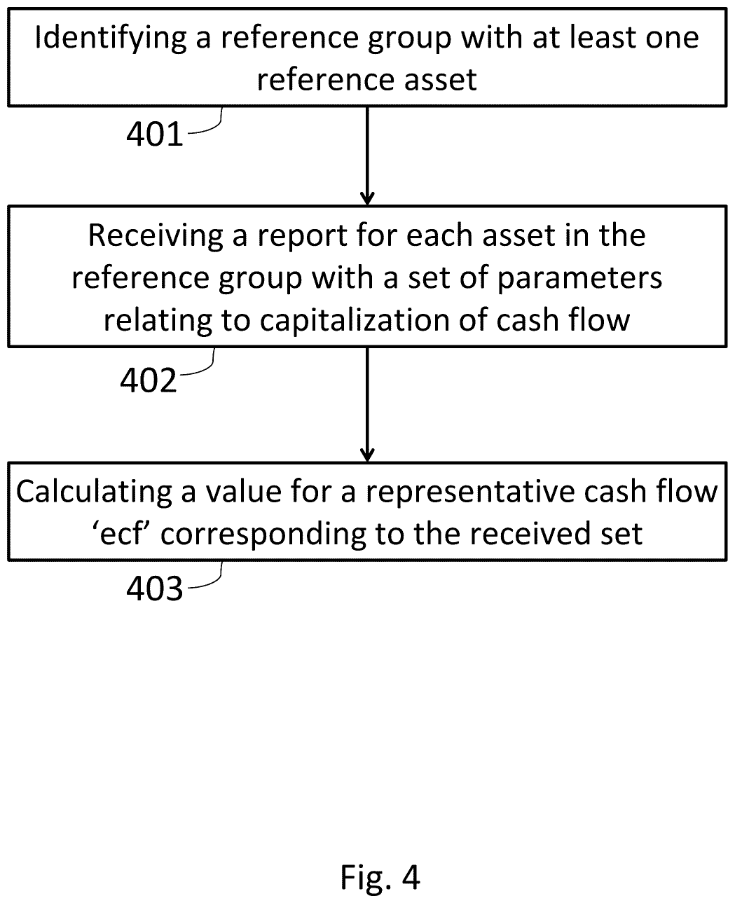

Reference is made to FIG. 4, which shows a flowchart for a method of predicting changes in values of an asset, according to some embodiments of the invention.

At step 401, a reference group 203 with at least one reference asset 204 may be identified (e.g., by the processor 202). At step 402, a report 205 for each asset 204 in the reference group 203 may be received (e.g., by the processor 202) with a set of parameters 206 relating to capitalization of cash flow. In some embodiments, the report 205 and/or set of parameters 206 may be stored at the database 201. In some embodiments, the report 205 may include details for at least one of: an equivalent cash flow (‘ecf’) and liabilities.

The received set of parameters 206 may include: a value for a debt ‘D’ for the asset, and/or a value for a cost of the debt ‘rd’ for the asset, and/or a value for a tax ‘T’ for the asset, and/or a value for an expected growth rate ‘eg’ for the asset.

At step 403, a value for an equivalent cash flow ‘ecf’ 210 may be calculated (e.g., by the processor 202), the value ‘ecf’ 210 corresponding to the received set 206. A value for an estimated short-term adjustment ‘sta’ 211 may also be calculated as the sum of differences in a previous year. In some embodiments, ‘ecf’ 210 may be calculated according to the equation:

$$ecf = ( cfn / ( 1 + eg ) ) \hat{} ( n - m ) .$$

where ‘n’ is a predefined equivalent capitalization year, and ‘m’ is a different predefined year, such that a capitalized cash flow of the representative year is calculated according to a calculated growth rate ‘gl’ of the representative year until the first year, and where ‘cfn’ is the equivalent cash flow for the year ‘n’.

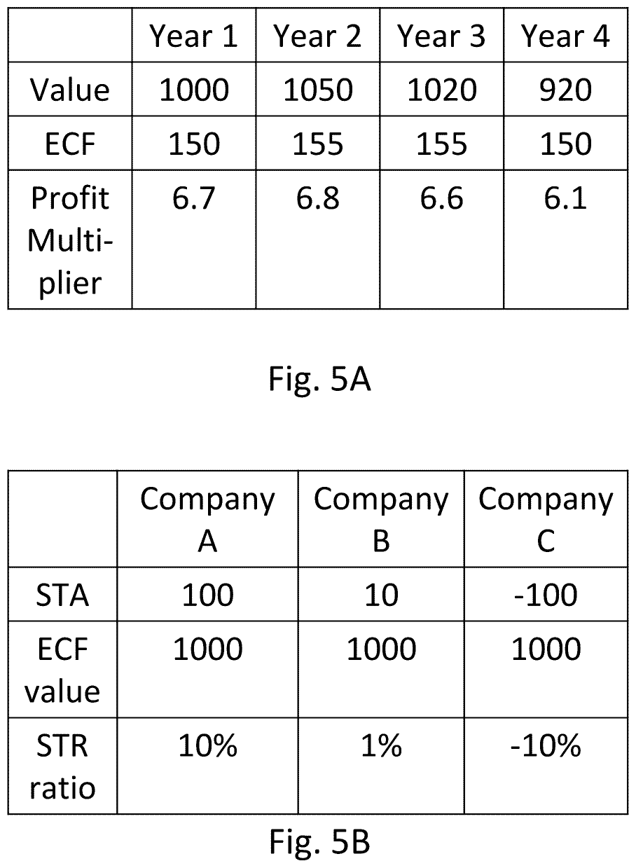

Reference is made to FIG. 5A, which shows a table with an example of ‘ECF’ and embedded multiplier calculation by the system 200 for a period of several years, according to some embodiments of the invention. The ‘ecf’ may be expected to be consistent over time and any change in it may be a point for detailed analysis. Thus, a long-term comparison of assessments may accordingly provide knowledge of future trends. Decomposition of the value component according to the abovementioned equations may allow a clear understanding of the user about the components of the value of the asset.

Referring to the example in FIG. 5A, in year 1, the ‘ecf’ may be calculated without comparisons. In year 2 vs year 1, there was an increase in value that may be due to the increase in the cash flow, the change in value may be measured against the ratio of the change in the cash flow. In year 3 vs year 2, there was no change in the cash flow, and any decrease in value may be due only to the effect of other parameters such as an increase in market yield. In year 4 versus year 1, the cash flow remained low, but the value fell, and this may be due to the influence of other parameters such as an increase in market yield. Changes in the effect of the short-term may not affect the value as they are only realized in another form of asset or liability. Thus, the significance of the given flow may be high in comparative analyzes over time. For example, if a company ‘B’ in year 4 has a value of 500 and calculated ‘ecf’ of 90 and ‘ecf’ multiplier of 5.5, then the market value may also be taken into consideration. In year 4, the market value may be 7,000,000 and calculated ‘ecf’ of 1,200,000 and ‘ecf’ multiplier of 5.8, then the value derived from the market multiplier 5.8 may represent a value of 5.8*90=522, which means that the market value may be expected to increase to 522 instead of the value of 500 of company ‘B’. Accordingly, the user may get an easier understanding with fewer parameters in order to predict future behavior.

The profit multipliers may allow investment comparison and valuation of the asset derived from market multipliers. A low multiplier may indicate shorter investment return years and an advantage in investing in them, while a low multiplier relative to the market may be an advantage. Thus, comparison of different groups of duplicates and/or the market may be carried out to match the level of uniform leverage. For example, if company ‘A’ leverage is 20% and its profit multiplier is 9 while company ‘B’ has a leverage of 80% and its profit multiplier is 3, it may be difficult to compare between them. In case that the market leverage is 40% and its multiplier is 7 then we have adjust both multipliers of the companies to market leverage rate or any other standard in order to compare profit multipliers.

Reference is made to FIG. 5B, which shows a table with an example of comparison of ‘ECF’ based value and ‘STA’ calculation by the system 200 for several companies, according to some embodiments of the invention. The ‘STR’ ratio of the short-term cash flow to the ‘ecf’ valuation effect of the cash flow may be an indication of likelihood, where the smaller the ratio the less inconsistent changes may be observed. The ratio may be calculated as the ‘sta’ over the total value instead of the permanent component.

A positive 10% ratio for company ‘A’, with ‘sta’ value of 100 and ‘ecf’ based value of 1000, may indicates that in the short term there may be an increase in value that arises only in the short term, but the low flow may be in the short and long terms. A 1% ratio for company ‘B’, with ‘sta’ value of 10 and ‘ecf’ based value of 1000, may indicate flow operational stability and provide reasonable assurance. A negative 10% ratio for company ‘C’, with ‘sta’ value of −100 and ‘ecf’ based value of 1000, may indicate that in the short term there may be a reduction in value arising only from the short-term which may raise concerns that the cash flow is estimated to be higher.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A method of predicting changes in values of an asset, the method comprising:
receiving, by a processor, a report for the asset with a set of parameters relating to capitalization of cash flow, wherein the received set of parameters comprises:
a value for a debt ‘D’ for the asset;
a value for a cost of the debt ‘rd’ for the asset;
a value for a tax ‘T’ for the asset;
a value for an expected growth rate ‘eg’ for the asset;
calculating, by the processor, a value for an estimated short-term adjustment ‘sta’ as the sum of differences in previous years; and
calculating, by the processor, a value for an equivalent cash flow ‘ecf’ corresponding to the received set, according to the equation:
$$ecf = ( cfn / ( 1 + e g ) ) \hat{} ( n - m )$$
wherein ‘n’ is a predefined representative capitalization year and ‘m’ is a different predefined year such that a capitalized cash flow of the representative year is calculated until the first year, and wherein:
‘cfn’ is the equivalent cash flow for the year ‘n’; and
‘cfm’ is the equivalent cash flow for the year ‘m’.

2. The method of claim 1, further comprising:
identifying, by the processor, a reference group with at least one reference asset; and
receiving, by the processor, a report for each asset in the reference group.

3. The method of claim 2, wherein the report further comprises details for at least one of: a equivalent cash flow (‘ecf’) and liabilities.

4. The method of claim 2, further comprising:
receiving, by the processor, a report with a set of parameters relating to capitalization of cash flow, wherein the received set of parameters comprises:
a value for a calculated asset worth ‘v’ for the asset; and
a value for a capital market value ‘e’ for the asset;
calculating a value for a return on equity inherent in the share price ‘re’ for the asset; and
$$calculating w = D / v * rd * ( 1 - T ) + e / v * re .$$

5. The method of claim 4, further comprising normalizing the calculated equivalent cash flow ‘ecf’ for each asset in the reference group based on the share price ‘re’ for the asset.

6. The method of claim 1, further comprising calculating adjustments to the equivalent cash flow (‘ecf’) based on differences for at least one other year.

7. The method of claim 1, further comprising applying a looping algorithm to calculate three equations:
$$V = D + E \qquad ( I )$$
$$V = \frac{ecf}{( W - eg )} - sta \qquad ( II )$$
$$W = \frac{E}{V} * RE - \frac{D}{V} * rd * ( 1 - T ) . \qquad ( III )$$

8. The method of claim 1, further comprising calculating an implied market yield ‘my’ for the reference group.

9. The method of claim 8, further comprising calculating a return on equity ‘re’ with the equation: RE=rf+(my−rf)*β, wherein ‘rf’ is the risk-free interest rate and ‘β’ is the standard correlation coefficient.

10. A system for prediction of changes in values of an asset, the system comprising:
a processor; and
a database, coupled to the processor and configured to store a report for the asset with a set of parameters relating to capitalization of cash flow;
wherein the processor is configured to:
receive the report from the database, wherein the received set of parameters comprises:
a value for a debt ‘D’ for the asset;
a value for a cost of the debt ‘rd’ for the asset;
a value for a tax ‘T’ for the asset;
a value for an expected growth rate ‘eg’ for the asset;
calculate a value for an estimated short-term adjustment ‘sta’ as the sum of differences in a previous year; and
calculate a value for an equivalent cash flow ‘ecf’ corresponding to the received set, according to the equation:
$$ecf = ( cfn / ( 1 + eg ) ) \hat{} ( n - m )$$
wherein ‘n’ is a predefined representative capitalization year and ‘m’ is a different predefined year such that a capitalized cash flow of the representative year is calculated until the first year, and wherein:
‘cfn’ is the equivalent cash flow for the year ‘n’; and
‘cfm’ is the equivalent cash flow for the year ‘m’.

11. The system of claim 10, wherein the processor is further configured to:
identify a reference group with at least one reference asset; and
receive a report for each asset in the reference group.

12. The system of claim 10, wherein the report further comprises details for at least one of: an equivalent cash flow (‘ecf’) and liabilities.

13. The system of claim 10, wherein the processor is further configured to:
receive a report with a set of parameters relating to capitalization of cash flow, wherein the received set of parameters comprises:
a value for a calculated asset worth ‘v’ for the asset; and
a value for a capital market value ‘e’ for the asset;
calculate a value for a return on equity inherent in the share price ‘re’ for the asset; and
calculate w=D/v*rd*(1−T)+e/v*re.

14. The system of claim 10, wherein the processor is further configured to normalize the calculated equivalent cash flow ‘ecf’ for each asset in the reference group based on the share price ‘re’ for the asset.

15. The system of claim 10, wherein the processor is further configured to calculate adjustments to the equivalent cash flow (‘ecf’) based on differences for at least one other year.

16. The system of claim 10, wherein the processor is further configured to calculate an implied market yield ‘my’ for the reference group.

17. The system of claim 16, wherein the processor is further configured to calculate a return on equity ‘re’ with the equation: RE=rf+(my−rf)*β, wherein ‘rf’ is the risk-free interest rate and ‘β’ is the standard correlation coefficient.

18. The system of claim 10, wherein the processor is further configured to apply a looping algorithm to calculate three equations:
$$V = D + E \qquad ( IV )$$
$$V = \frac{ecf}{( W - eg )} - sta \qquad ( V )$$
$$W = \frac{E}{V} * RE - \frac{D}{V} * rd * ( 1 - T ) . \qquad ( VI )$$
